(19) United States
(12) Patent Application Publication
(10) Pub. No.: US 2002/0076024 A1
(43) Pub. Date: Jun. 20, 2002

(54) Method, device and software for assessing urgency of incoming communications

(75) Inventor: Paul M. Brennan, Toronto (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/739,706

(22) Filed: Dec. 20, 2000

(51) Int. Cl. H04M 3/42

(52) U.S. Cl. 379/201.01

(57) ABSTRACT

Methods, devices and software for assessing urgency of incoming communications are disclosed. Using these, the likely urgency of an incoming communication from an originator to a recipient may be assessed using a maintained log of past incoming communications for the recipient. Upon receipt of the incoming communication the log is examined to assess the urgency, taking into account the pattern of prior communications from the originator.

### FIELD OF THE INVENTION

The present invention relates to communication processing and more particularly to a method, device and software for assessing urgency of incoming communications including calls, electronic messages and the like.

### BACKGROUND OF THE INVENTION

In recent years, individuals have become overwhelmed by incoming electronic communications. Individuals appear to be always accessible. At work or at home they may be reached by telephone, voicemail, facsimile, or electronic mail; while travelling they may be reached by pager, cell phone or personal digital assistant. With all these ways of reaching an individual, it is no wonder that individuals are becoming overwhelmed by incoming communications. Undoubtedly this problem will become more pronounced as telecommunications networks expand, and as existing communications systems are integrated, so that facsimiles, voice mail, e-mail, and telephone calls are received and sent using integrated devices and systems.

As the volume of communications increases, many are not processed effectively. For example, many incoming live telephone calls are ignored and often forwarded to voice messaging systems, regardless of their importance. E-mail messages may be ignored.

Not surprisingly, communications devices have addressed ways of identifying the source of incoming communications, and ordering and processing these communications, based on their origin. For example, U.S. Pat. No. 5,329,578 discloses a personal communications system (“PCS”) that processes incoming communications based on defined rules. This system is effective in processing incoming communications from known originators, at defined times and may route calls based on the origin, urgency and time of call.

Existing e-mail protocols allow e-mail originators to flag messages as urgent. As well, U.S. Pat. No. 6,057,841 describes an e-mail application that allows messages to be sorted based on user defined rules. These rules may cause the e-mail client to examine attributes of incoming e-mails and sort the e-mails based on these attributes. This technique is effective for messages whose attributes are known. However, when e-mail that does not fit a defined pattern is received, user-defined rule based handling may not be adequate.

In view of these e-mail protocols, e-mail originators have become accustomed to specifying message urgency. Other types of communications, such as telephone calls, typically do not allow originators to specify urgency of their outgoing communications. Even where systems do provide a feature allowing originators the option to specify urgency, such as some voice mail systems, the feature is typically not used as originators are often unfamiliar with it.

More significantly, existing approaches of assessing urgency rely on a static view of the priority of communications from originators, or on an originator's ability to prioritize a communication for a recipient.

Accordingly, improved methods, software and devices for processing communications to facilitate prioritizing of such communications are desirable.

### SUMMARY OF THE INVENTION

In accordance with the present invention, the likely urgency of an incoming communication from an originator to a recipient may be assessed by maintaining a log of past incoming communications for the recipient, and upon receipt of the incoming communication, examining the log to assess the urgency, taking into account the pattern of prior communications from the originator.

In accordance with an aspect of the present invention, a method of assessing the urgency of an incoming communication from an originator to a recipient, implemented by a computer, includes maintaining a log of past incoming communications for the recipient, and upon receipt of the incoming communication, examining the log and based on previous communications from the originator, assessing the urgency.

In accordance with another aspect of the present invention, a computing device includes a processor, and computer readable memory in communication with the processor and storing application software adapting the processor, upon receipt of an incoming communication from an originator to a user to examine a log reflecting past incoming communications for the user to assess an urgency of the incoming communication, based on past communications from the originator.

In accordance with yet another aspect of the present invention, a computer readable medium stores processor executable instructions, that when loaded at a computing device having access to a log of past incoming communications for a user, adapt the computing device to examine the log to assess an urgency of a current incoming communication from an originator to the user, based on past incoming communications from the originator.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of this invention:

FIG. 1 illustrates a messaging server exemplary of an embodiment of the present invention, in communication with a data and telephone network;

FIG. 2 schematically illustrates the architecture of the exemplary device of FIG. 1;

FIG. 3 illustrates the organization of memory of the device of FIG. 1;

FIG. 4 illustrates an exemplary organization of a log reflecting received incoming communications for a user of the server of FIG. 1; and

FIG. 5 illustrates exemplary steps performed by the server of FIG. 1 upon receipt of an incoming communication.

### DETAILED DESCRIPTION

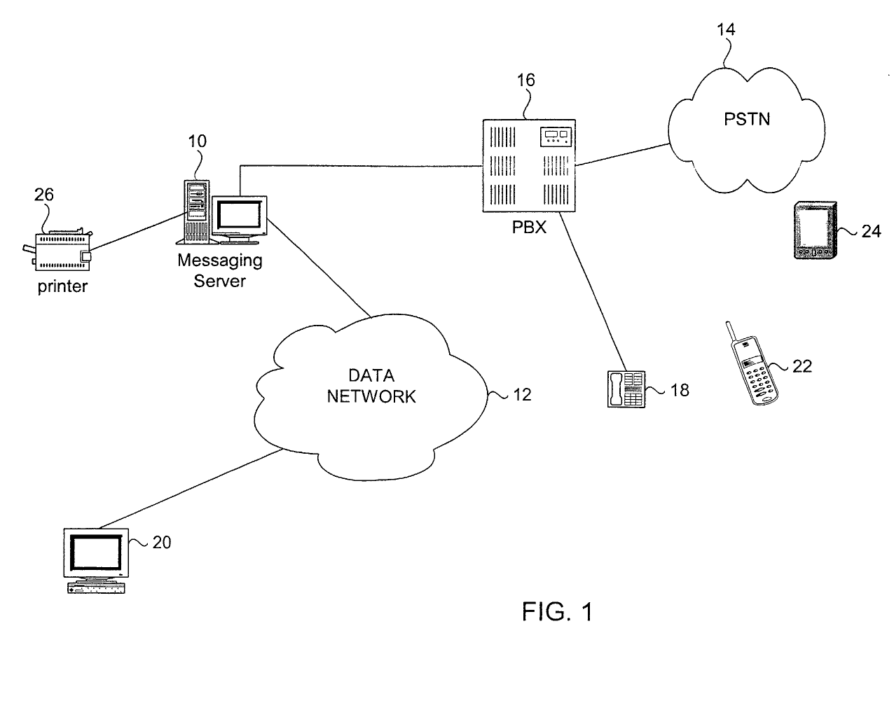

FIG. 1 illustrates an incoming messaging server 10, exemplary of an embodiment of the present invention. Messaging server 10 is in communication with a data network 12, and telephone network 14. As illustrated, messaging server 10 may be directly interconnected with network 12 and indirectly to telephone network 14 through private branch exchange 16 (“PBX”) telephone switch. Messaging server 10 may, for example, be a CallPilot communications server available from Nortel Networks, modified to function in a manner exemplary of the present invention. Messaging server 10 is in communication with a plurality of communications devices associated with an individual end-user. Example messaging devices may include illustrated computing device 20; mobile phone 22; personal digital assistant (“PDA”) 24; and telephone 18. A conventional printer 26 is also in communication with server 10.

Example messaging server 10 is adapted to provide unified messaging to a plurality of users associated with server 10. Messaging server 10 may, for example, process incoming communications to a commonly linked group of individuals, such as for example, workers within an office. Typically, a single user will be associated with an e-mail address, for receipt of e-mails at a computing device such as device 20; a telephone number for receipt of calls at a phone such as telephone 18; and a telephone number for receipt of facsimiles at device 20. Optionally, server 10 could be associated with other communications devices associated with a user. For example, calls to portable devices, such as phone 22 and PDA 24 could be routed through PBX 16 and/or server 10.

Example data network 12 is preferably a packet switched communications network that allows interconnected computing devices to exchange data using known packet based protocols, such as the internet protocol (“IP”), as detailed in RFC 791. Network 12 may for example be the public internet, a local area network, or a private intranet, that is preferably in communication with other data networks, and ultimately the public internet.

Telephone network 14 is preferably the public switched telephone network (the “PSTN”). PDA 24 and portable telephone 22 are preferably in communication with telephone network 14 and data network 12, by way of suitable wireless communications networks (not illustrated) and gateways (also not illustrated) coupling such networks to telephone network 14 and data network 12.

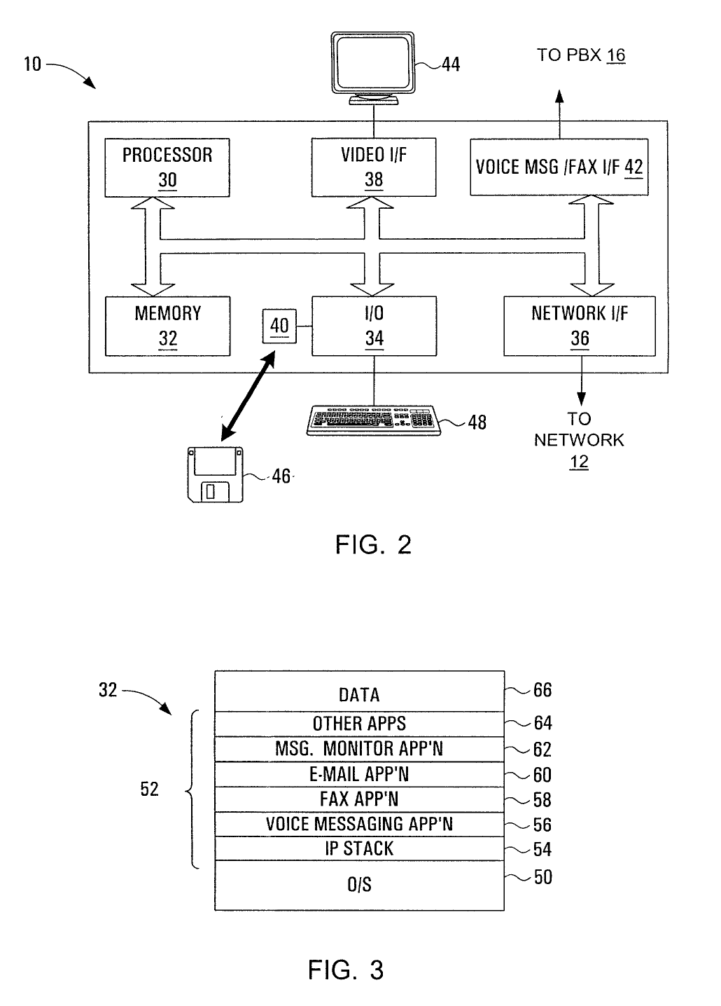

A simplified preferred architecture of server 10 is schematically illustrated in FIG. 2. In the illustrated embodiment, server 10 is a conventional computing device. Server 10 could, for example, be an Intel x86 based computer acting as a Microsoft Windows NT server, or another personal computer, or the like.

Server 10 includes a processor 30, in communication with computer readable memory 32; data network interface 36; input/output interface 34; telephone network interface 42; and video adapter 38. As well, server 10 may optionally include a display 44 interconnected with adapter 38; input/output devices, such as a keyboard 48 and disk drive 40 and a mouse (not shown) or the like. Processor 30 is typically a conventional central processing unit, and may for example be a microprocessor in the INTEL x86 family. Of course, processor 30 could be any other suitable processor known to those skilled in the art. Computer storage memory 32 includes a suitable combination of random access memory, read-only-memory, and disk storage memory used by server 10 to store and execute software programs adapting server 10 to exchange communications using network 12, and manage received communications in manners exemplary of the present invention. Drive 40 is capable of reading and writing data to or from a computer readable medium 46 used to store software and data to be loaded into memory 32. Computer readable medium 38 may be a CD-ROM, diskette, tape, ROM-Cartridge or the like. Network interface 36 is any interface suitable to physically link server 10 to network 12. Interface 36 may, for example, be an Ethernet, ATM, ISDN interface or modem that may be used to pass data from and to data network 12 or another suitable communications network. Telephone interface 42 may be a suitable ISDN/DS1 interface, including voice processor such, as for example, the telephone interface integrated into existing CallPilot products, or similar interfaces available from Dialogic of Parsippany, N.J. As such, interface 42 may be capable of receiving and digitzing voice signals from PBX 16 and thus telephone network 14. Telephone interface 42 may also act as a facsimile modem, to receive facsimile transmissions from telephone network 14, and form suitable TIFF files representative of transmitted facsimiles.

An exemplary organization of computer storage memory 32 of server 10 is illustrated in FIG. 3. As illustrated, stored within memory 32 are computer software programs and data that are used by processor 30 to permit server 10 to be operable as network communication capable device. As illustrated, memory 32 stores operating system software 50; application software 52; and data within data portion 66. Operating system software 50 may, for example, be Microsoft Windows NT Workstation operating system software, UNIX operating system software, or the like. Application software 52 includes network interface software 54 which typically includes an internet protocol stack allowing communication of server 10 and thus operating system 50 with network 12 (FIG. 1), through physical network interface 36 (FIG. 2). Application software 52 further include a electronic mail server application/library 60; a voicemail messaging application 56; and a facsimile server application 58; and a communication monitoring application 62, exemplary of an embodiment of the present invention. Other applications 64 used by users of data network 12 may also be stored within memory 32. Data within data portion 66 may be stored, processed and retrieved by processor 30 under control of applications 52 or operating system 50.

As understood by those skilled in the art, network interface software 54 may include internet stack that supports the basic internet protocol as detailed in RFC 791, TCP/IP and other internet protocols. Interface software 54 enables server 10 to exchange data over network 12 using known IP protocols, including messages that may be in the form of e-mail messages in the known simple mail transfer protocol (“SMTP”). Suitable internet protocol stacks are readily available for various platforms, and may form part of operating system 50.

Voicemail messaging application 56 adapts messaging server 10 to act as a voice mail server, allowing server 10 to receive incoming calls for subscribers from telephone network 14, by way of telephone network interface 42. Voicemail application 56 is conventional, and stores digitized voice messages in memory 32 in a conventional fashion. Stored messages may be incoming messages received by way of interface 42, or outgoing messages presented to incoming callers from telephone network 14 and presented through interface 42. Voicemail application 56, may thus allow server 10 to act as a voice message server for associated users of server 10. Preferably server 10 provides voice mail services to users of PBX 16, in the event calls are unanswered. Preferably, each stored message includes an indicator of the originator of the message. The indicator could be derived from calling line identification (CLID) information associated with a call leaving the message.

Facsimile server application 48 similarly adapts server 10 to receive facsimile messages from telephone network 14 for a particular user, also preferably by way of telephone network interface 42. Again, facsimile server application 48 may be a conventional facsimile application such that currently forming part of the CallPilot product. Typically, facsimiles are received in TIFF format, and may be stored within data portion 66 of memory 32 at server 10 and optionally printed at printer 26, or delivered to an end user as an e-mail message through e-mail server application 60, described below. Preferably, information reflecting the origin of a facsimile message as well as its destination are stored within data portion 66 memory 32 and associated with an incoming facsimile message. A facsimile's destination may be assessed based on the called facsimile telephone number; using optical character recognition; or in other ways understood by those of ordinary skill.

Additionally, e-mail server application 60 is a conventional e-mail messaging server application. It may for example, be a post-office-protocol, or IMAP compliant e-mail application, capable of receiving, storing and processing incoming e-mails received by way of data network 12 directed for users of server 10. Typically, received messages will comply with the SMTP. Messages may be stored for eventual retrieval by or forwarding to a user, at device 20, mobile phone 22, or PDA 24. Again, received e-mails including source and destination e-mail addresses are stored within memory 32. Optionally, e-mail server application 60 may also adapt server 10 to act as an SMTP server, capable of receiving outgoing e-mail messages from computing devices interconnected with network 12 (such as computing device 20) and dispatching these to others using the SMTP.

Exemplary communication monitoring application 62 receives data from voicemail application 56; facsimile server application 58; and e-mail application 60, and tracks and processes incoming communications in manners exemplary of the present invention. Application 62 may accomplish this by monitoring the contents of data portion 66 of memory 32, or alternatively by receiving indicators of incoming communications from applications 56, 58 and 60. Optionally, application 62 may also receive messages indicative of outgoing communications, such as e-mails or facsimiles, dispatched by users using applications 56, 58 or 60.

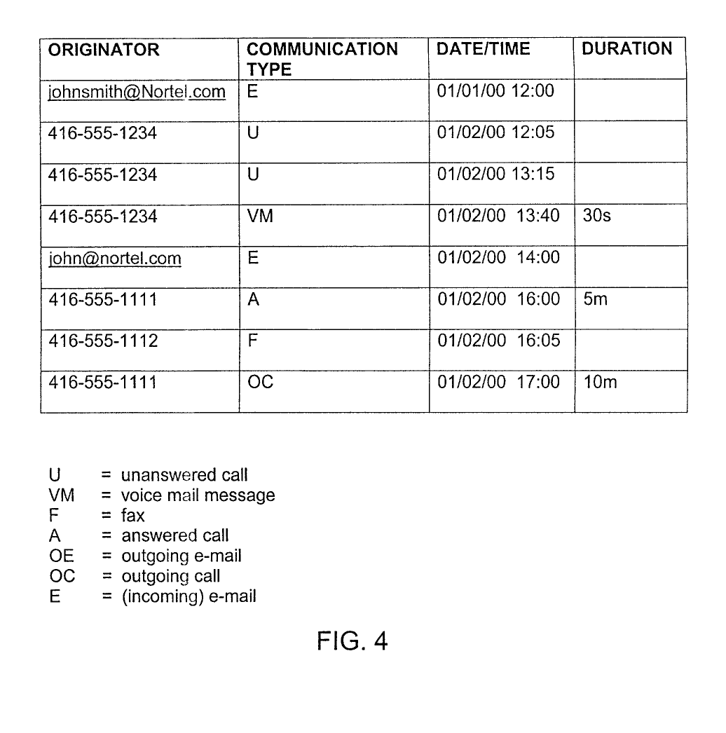

These messages may similarly be logged as records within log 100, as illustrated in FIG. 4. Log 100 is preferably associated with a single user of server 10, and may log communications to and from this user. As such, server 10 preferably stores multiple such logs, one for each user. As illustrated, each entry within log 100 preferably includes an identifier of the originator, preferably by e-mail address or calling line identification, as well as an indicator of the type of communication, time, and other information, such as message duration. Records are preferably added to log 100 in order of receipt or origination of a communication. Records within log 100 may be stored as ASCII text, and fields within records may be delimited using standard delimiters.

Exemplary communication monitoring application 62 further receives messages from PBX 16, indicative of incoming telephone calls to a users of server 10. Optionally, application 62 further receives messages indicative of outgoing calls from such user. Preferably, upon receipt of an indicator of an incoming call, answered or not, software at PBX will generate a message reflective of the incoming call and whether it has been answered to be passed to application 62 for storage in log 100. Again, each message may include the calling number; the communication type; start time; and duration. At the conclusion of a call, a record for storage in log 100 may be formed. This record may include an identifier of the caller, whether or not the call was answered; the duration; and an indicator of whether the call was answered or forwarded to another number (such as the number associated with the telephone interface associated with the voice mail software at server 10). Similarly, for outgoing calls, records representative of these calls may be stored within log 100, including suitable identifiers of the communications as outgoing calls. In the event server 10 is interconnected directly to telephone networks a conventional telephony switch forming part of network 14, modified to function in manners exemplary of the present invention, could provide messages indicative of incoming and outgoing calls to server 10.

In operation, communications originators (not illustrated) originate communications intended for an example recipient associated with server 10, such as a user of computing device 20 and telephone 18. Communications may take the form of real-time communications such as telephone calls, possibly resulting in voice-mail messages stored at server 10; e-mails or facsimiles stored at sever 10. Initially, all incoming communications are treated alike, or in accordance with handling rules, such as, for example, those described in U.S. Pat. No. 5,329,578 and known to those of ordinary skill. As will become apparent, records reflecting incoming communications are stored within log 100, as detailed below.

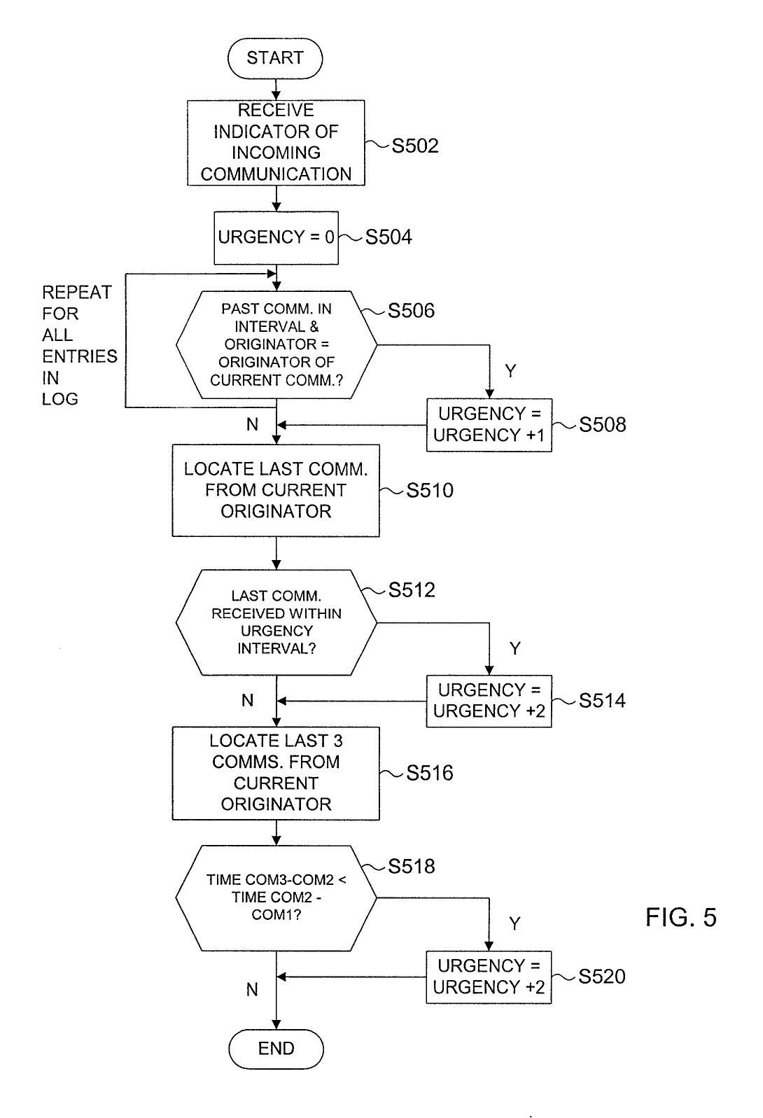

As well, in a manner exemplary of an embodiment of the present invention, and upon receipt of an incoming communication, monitoring application 62 checks log 100 to assess a perceived urgency of the incoming communication based on information stored within log 100. Exemplary steps S500 used to assess this urgency are illustrated in FIG. 5. As illustrated, upon receipt of an indicator of an incoming communication, application 62 receives a message indicative of the incoming communication in step S502, including the communication type and originator. Application 62 may calculate a value representative of this perceived urgency. As such, a variable storing a numerical value of communication urgency is reset in step S504. Next, application 62 compares the indicator of the incoming communication to records within log 100 to count the number of times the originator has attempted to contact the subject recipient in a given interval (e.g. a fixed time interval since the originator last communicated with the recipient) in steps S506-S508. For example, application 62 may assess the number of times the originator has attempted to contact the recipient in the last day, week or other suitable interval. Optionally application 62 may query a directory (not illustrated) to cross reference identifiers of originators of incoming communications, to assess which identifiers are common to, or associated with a single originator. For example, application 62 may assess if an e-mail address, telephone number, and facsimile identifier actually identify the same originator.

While querying the suggested directory, application 62 could further optionally assess if multiple individual originators are associated with each other or with the same organization. Using this option, the multiple communications from the multiple individual originators could be treated as communications from a single organizational originator, for the purposes of assessing priority in manners exemplary of the present invention. In this way, communications from any of the multiple associated individual originators would be indicative of a communication from the organization. Thus, as should now be appreciated, an originator, as used herein, may include multiple associated originators.

In any event, the number of times an originator has previously attempted to contact the recipient may be calculated by determining which records within log 100 are within a desired interval and have an originating address equal to (or equivalent to) that associated with the currently incoming communication. The desired interval may begin on a chosen date or time and optionally after a last communication has been received (e.g. an e-mail read, a voicemail heard, or a real-time communication with the originator initiated or answered by the recipient). The value of the number of times the particular originator may be added to the numerical urgency total in step S508.

Additional indicators of urgency that may be drawn from the contents of log 100 may be added to this value. For example, application 62 in step S510 locates the record within log 100 reflecting the last incoming communication by the originator of the current communication, and as such may assess the time lapsed since the last contact attempt. The shorter the time, the more the value of urgency may be adjusted. Thus, if the originator attempted to contact the recipient in the past hour as determined in step S512, the value may be increased by an additional nominal value (such as 2, for example), in step S514. Additionally, application 62 may examine log 100 to assess whether the frequency of contact is increasing, by comparing the duration between the last three communications as exemplified in steps S516-S520. If so, the calculated value of urgency may be increased by another nominal value, as exemplified in step S520. Of course, other indicators of urgency could be used to assess the overall urgency of an incoming communication.

If the total calculated value of urgency is greater than a pre-set value, which may be set by the user, application 62 may treat the communication as having taken on a sufficient urgency in the mind of the originator (as indicated by the frequency and interval of the of new communications by the originator). For example, if at the conclusion of steps S500, application 62 has associated an urgency of 6 or more with a communication, it may be treated as urgent.

Once application 62 assesses that an incoming communication has a certain urgency, it may mark the communication as urgent, and process it accordingly. For example, server 10 may dispatch a notification of the incoming to PDA 24 or portable phone 22, or another device. In the event the incoming communication is an e-mail or fax, and its assessed urgency exceeds the pre-set threshold, the entire communication may be forwarded to the PDA 24. Similarly, an indicator of a waiting voice mail message may be forwarded to PDA 24 or phone 22. Similarly, the communication may be modified to include an indicator of urgency. The indicator of urgency might be a binary value signifying urgency, or a numerical value within a range allowing multiple levels of urgency, depending on the assessed urgency. For example, the header of an incoming e-mail may be modified; an urgency field in the email could be modified; a cover page to a facsimile may be created or modified; or an urgency flag or value may be associated with an incoming voicemail before storage at server 10.

Alternatively, once server 10 detects the perceived urgency, any real time communication could be forwarded by server 10, in manners described in U.S. Pat. No. 5,329,578 to an alternative destination. The alternative destination could be a telephone device in communication with communication telephone network 14, or a data network capable device in communication data network 12.

As will also be appreciated, in the event that an incoming communication includes its own pre-set identifier of urgency, (e.g. an urgency flag associated with an e-mail, or the like), the communication may optionally be processed using existing processing rules instead of steps S500.

Although the invention has been described in the context of a messaging server 10 capable of processing incoming phone calls, e-mail messages, and facsimile message, a person of ordinary skill will readily appreciate that the invention could be used to process all types of communications of numerous types from diverse communications networks. So for example, server 10 could easily be adapted to process incoming real-time data network communications, such as voice over IP calls received by way of data network 12; multimedia communications received, for example a video call, by way of network 12; wireless network communications received from a suitable gateway or directly; as well as other incoming communications readily appreciated by a person of ordinary skill. Similarly, while messaging server 10 has been illustrated as a separate device, a person of ordinary skill will readily appreciate that the functionality of server 10 could be integrated with other communication equipment. For example, components of server 10 could be integrated into a telephony switch, or other data network or PSTN node.

Similarly, while the organization of hardware, software functional blocks, and data have been illustrated as clearly delineated, a person skilled in the art will appreciate that the delineation between blocks is somewhat arbitrary. Numerous other arrangements of hardware, software blocks and data are possible. For example communications records for all users could be stored in a single log. A log, such as log 100 could be stored as a database or otherwise. The functionality of server 10 could for example be distributed across numerous communicating computing devices. So for example, application 62, exemplary of an embodiment of the present invention could be stored and executing at a first computing device, in communication with other computing devices capable of receiving e-mails, facsimiles, voice mail messages, and the like.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modifications within its scope, as defined by the claims.

What is claimed is:

1. A method of assessing the urgency of an incoming communication from an originator to a recipient implemented by a computer, said method comprising,
maintaining a log of past incoming communications for said recipient, and
upon receipt of said incoming communication, examining said log and based on previous communications from said originator, assessing said urgency.

2. The method of claim 1, wherein said incoming communication comprises one of a facsimile transmission, an e-mail, a multi-media communication, an attempted telephone call, and a voice mail message.

3. The method of claim 1, wherein said examining comprises determining an interval since a last communication from said originator.

4. The method of claim 1, wherein said examining comprises assessing a duration since any of said originator's communications have been answered or returned.

5. The method of claim 1, wherein said assessing comprises calculating a numerical indicator of urgency including a number of received prior incoming communications from said originator in a time interval prior to receipt of said incoming communication.

6. The method of claim 5, further comprising, in response to calculating an indicator having a value above a threshold, identifying said incoming communication as urgent to said recipient.

7. The method of claim 6, wherein said incoming communication comprises an electronic mail message and said identifying comprises modifying said electronic mail message to identify it as urgent.

8. The method of claim 6, wherein said identifying comprises notifying a device associated with said recipient of said incoming communication.

9. The method of claim 1, wherein said maintaining comprises recording a type of each of said past incoming communications.

10. The method of claim 9, wherein said log stores a time of each of said past communications.

11. The method of claim 10, further comprising maintaining records of outgoing communications by said user.

12. A computing device, comprising
a processor;
computer readable memory in communication with said processor and storing application software adapting said processor, upon receipt of an incoming communication from an originator to a user to:
examine a log reflecting past incoming communications for said user to assess an urgency of said incoming communication, based on past communications from said originator.

13. The computing device of claim 12, wherein said log stores a time of each of said past communications.

14. The computing device of claim 13, wherein said log stores an indicator of a communications type for each of said past communications.

15. Computer readable medium, storing processor executable instructions, that when loaded at a computing device having access to a log of past incoming communications for a user, adapt said computing device to examine said log to assess an urgency of a current incoming communication from an originator to said user, based on past incoming communications from said originator.
